(19) United States
(12) Patent Application Publication
(10) Pub. No.: US 2020/0306131 A1
(43) Pub. Date: Oct. 1, 2020

(54) STATIONARY FOAM ROLLER WITH AN ADJUSTABLE MOUNT

(71) Applicant: Roth WEINSTEIN, Solana Beach, CA (US)

(72) Inventor: Roth WEINSTEIN, Solana Beach, CA (US)

(21) Appl. No.: 16/368,787

(22) Filed: Mar. 28, 2019

(51) Int. Cl. A61H 15/00; A61H 15/02

(52) U.S. Cl. CPC A61H 15/00; A61H 15/02; A61H 2201/0123; A61H 2201/02; A61H 2015/0071; A61H 2201/169; A61H 2205/081; A61H 2201/1253; A61H 2015/0014

(57) ABSTRACT

A foam roller system that may be used on a floor or mounted to a vertical surface such as a door or wall. The system may include stands that attach to a central axle inside the foam roller, and detachable mounting straps that attach to the stands; the straps may be hooked for example around the edges of a door to mount the roller system on a door. The position of the roller on the door may be adjusted by sliding the stands along the straps. The roller may include thermal and vibration elements to enhance therapies. The stands may have resistance elements to provide resistance to rolling.

### BACKGROUND OF THE INVENTION

### Field of the Invention

One or more embodiments of the invention are related to the field of exercise and rehabilitation equipment. More particularly, but not by way of limitation, one or more embodiments of the invention enable a stationary foam roller with an adjustable mount.

### Description of the Related Art

Foam rollers are often used for self-message or physical therapy. Although they offer some benefits, simple foam rollers have several limitations. First, when self-rolling ones back or other muscle groups, the simple foam roller tends to incrementally move unidirectional across the room as the user moves back and forth on the roller. Often, the user must get up to reposition the foam roller to complete a massaging session. Second, due to this unidirectional motion of the roller, rolling some muscle groups require the user to support their entire body weight, which for inexperienced users can be painful and require too much strength. The user has to continually reposition his/her feet while massaging his/her back to prepare for the next back-forth cycle. And when his/her feet are raised to move, more body weight has to be momentarily supported by the foam roller. This results in extra support force of the roller on the muscles and frequently causes increased pain. Additionally, another shortcoming of the conventional foam roller, that is often overlooked, is that it is normally placed on the floor, a location that is challenging for someone with reduced capacity for movement. Getting down and back up off of the floor is especially difficult for some of the elderly who might otherwise benefit from foam rolling. Finally, the simple foam roller tends to cling and tug on the user's clothing and often traps it between the roller and the floor. If this occurs, the user must interrupt his/her massage session to correct the situation.

To overcome some of these limitations, some companies have developed stationary foam rollers with stands. Illustrative products in this category include for example the HighRoller™ made by HighRoller Finland Ltd., and the Rogue MobilityWOD BattleStar™ made by Rogue Fitness. While these rollers are stationary, they are limited to on-floor use. They cannot be mounted on a vertical surface such as a wall or a door. This limits the flexibility of the roller system.

For at least the limitations described above there is a need for a stationary foam roller with an adjustable mount.

### BRIEF SUMMARY OF THE INVENTION

One or more embodiments described in the specification are related to a stationary foam roller with an adjustable mount. Embodiments of the invention may be used for massage, stretching, exercising, and physical therapy. They may be used for self-myofascial release, a form of massage that is used by athletes and physical therapists to sooth or inhibit overactive muscles. Myofascial-release is thought to complement stretching and help with warming up (injury prevention) and post workout recovery for both casual and professional athletes. It is also beneficial for anyone who suffers from minor muscular aliments.

One or more embodiments may include a cylindrical foam roller with a solid shaft that is positioned along the centerline of the cylindrical foam roller that extends beyond the roller's end faces. The shaft's two free ends may be plugged and set into a stand structure so that the foam roller is suspended above the floor or offset from another mounting surface, and it is free to roll on within the stands. When in use, the stands may remain stationary while the user moves various parts of his/her body back and forth over the immobilized foam roller that can only rotate. This modified apparatus is referred to as a stationary foam roller.

Because the use of stands causes the foam roller to be stationary when in use, it does not incrementally move across the floor. This means that the user does not have to reposition his/her feet after each back and forth cycle and risk added pressure on his/her back that could cause discomfort or pain. In addition, the gap between the bottom of the foam roller and the floor (or other surface) eliminates the undesired tendency to trap the user's clothing between the roller and the floor.

In one or more embodiments the roller and stands may be mounted to a vertical surface such as a wall or door. Vertical surface mounting may be especially helpful for elderly people who have difficulty getting up and down from the floor. A majority of the stretches, massages, and therapies that can be done on the floor can still be performed with a foam roller mounted on a vertical surface.

One or more embodiments of the invention may include a cylindrical foam roller, an axle along the longitudinal axis of the roller that is coupled to the roller, and a pair of stands that connect to either side of the axle. Each stand may have a base with one or more bottom surfaces that rest on a mounting surface, such as a floor, wall, or door for example, a body, a connector to the axle, and a strap mount. The connector to the axle may be attached or detached. When attached, the axle may rotate freely relative to the body of the stand. The connector may be offset from the bottom surfaces of the base so that the foam roller may rotate freely above the mounting surface. The strap mount may include a strap with a hook at each end that attaches to a mounting surface, and a strap holder that connects to the body of the stand. The strap holder may have one or more slots that the strap passes through; the strap holder may slide along the strap so that it can be positioned at multiple positions.

In one or more embodiments the axle may be hollow, and the connector from the stand to the axle may have a cylindrical protrusion from the stand body that fits inside the axle.

In one or more embodiments the strap mount may be detachable from the body of the stand. The foam roller and stands may therefore be usable without the straps, for example on a floor.

One or more embodiments may incorporate a locking mechanism that locks the connector to the axle.

In one or more embodiments the base may have one or more feet. The bottom surfaces of the feet may have a compliant material, such as rubber.

In one or more embodiments the foam roller may include a vibrating element. In one or more embodiments it may include a thermal element.

In one or more embodiments, the stand may include a resistance element that resists rotation of the foam roller and the axle. The resistance element may be for example an impeller, which may be inside a fluid-filled housing.

### BRIEF DESCRIPTION OF THE DRAWINGS

The above and other aspects, features and advantages of the invention will be more apparent from the following more particular description thereof, presented in conjunction with the following drawings wherein:

FIGS. 1A and 1B show an embodiment of a stationary foam roller mounted to a door in different positions.

FIG. 2 shows the stationary foam roller of FIGS. 1A and 1B mounted to the door in a different orientation.

FIG. 3 shows an embodiment of a stationary foam roller with mounting straps for attachment to a door or similar mounting surface.

FIGS. 4A and 4B show top and bottom views, respectively, of the mounting straps of the embodiment of FIG. 3.

FIG. 5 shows the stationary foam roller of FIG. 3 with the mounting straps removed, in a configuration suitable for use on a floor for example.

FIG. 6 shows the left and right stands of the stationary foam roller of FIG. 5.

FIG. 7 shows the stationary foam roller of FIG. 5 with the stands removed.

FIG. 8 shows an exploded view of the stationary foam roller of FIG. 7, showing the inner axle and the surrounding foam cylinder.

FIG. 9 shows the stationary foam roller of FIG. 5 with internal thermal and vibration elements.

FIG. 10 shows a stand of a stationary foam roller with an integrated resistance element to resist fast rotation of the roller.

### DETAILED DESCRIPTION OF THE INVENTION

A stationary foam roller with an adjustable mount will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

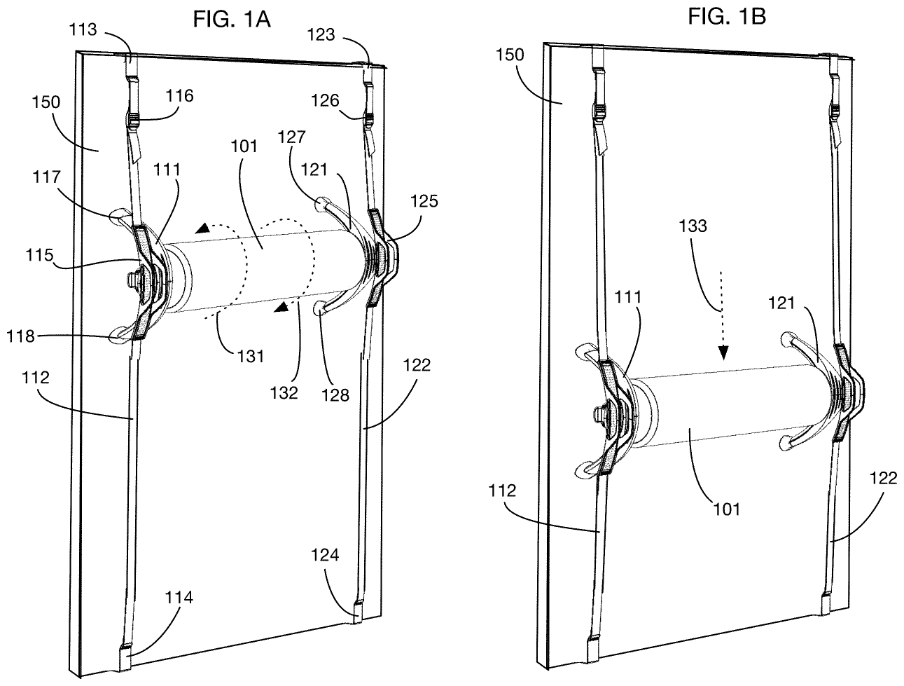

FIGS. 1A and 1B illustrate an embodiment of the invention mounted to a door 150. One or more embodiments of the invention may include a foam roller with a multi-use, adjustable mounting system that enables the roller to be mounted to a variety of surfaces or objects. Door 150 is an illustrative surface that the system may be mounted to. Other surfaces or objects that embodiments of the invention may be mounted to may include for example, without limitation, a window, a wall, a table, a post, a pillar, a column, a tree, a bookcase, an armoire, a closet, a closet door, a floor, a ceiling, or any piece of furniture.

The embodiment shown in FIG. 1A has a cylindrical foam roller 101 suspended between two stands 111 and 121, which rest on the surface of door 150. The stands extend the roller 101 away from the door so that there is a gap between the door surface and the roller surface, thereby enabling the roller to roll freely in either direction 131 or 132. The roller is stationary relative to the door because it is held in place by the stands with only rotational freedom around its central longitudinal axis. A user may therefore use the roller for self-massage, stretching, exercise, or physical therapy in a standing, sitting, or squatting position. In the embodiment shown in FIG. 1A, the stands have a U-shaped form; this form is illustrative, and one or more embodiments may have stands of any size or shape. Stand 111 has two feet 117 and 118, each with a substantially flat bottom surface that rests against the surface of door 150 or any other mounting surface. Similarly stand 121 has feet 127 and 128. The bottom surfaces of feet 117, 118, 127, and 128 may be made of rubber or another compliant material to aid in conforming to the mounting surface and to holding the stands in position on this surface.

The roller and stands are mounted to door 150 with mounting straps on either side. Strap 112 attaches to the door using hooks 113 and 114. Strap 122 attaches to the door using hooks 123 and 124. Hooks 113, 114, 123, and 124 may be of any size, shape, and material. In one or more embodiments, the hooks may be or may include suction cups, magnets, brackets, screws, bolts, clamps, ties, or any other coupling device or devices. Strap 112 may be tightened or loosened using cinch 116; similarly, strap 122 may be tightened or loosened using cinch 126. In one or more embodiments, straps 112 and 122 may be or may include ropes, cords, springs, strings, bands, or any other type or types of linear elements that enable attachment to a surface or object.

Strap 112 runs through slots in strap holder 115, which is coupled to the body of stand 111. Similarly strap 122 runs through slots in strap holder 125, which is coupled to the body of stand 121. Tension in the straps presses the stands against the door, securing them in position. The straps may move freely through the slots in the strap holders, particularly when tension is temporarily reduced (for example using the cinches); this degree of freedom allows the cylindrical foam roller and the stands to be repositioned vertically at any position along the door. This repositioning is illustrated in FIG. 1B, where the roller and stands are displaced by motion 133 to a lower position on the door. This adjustability in mounting position provides convenience and flexibility for the user. For example, the user may put the roller in the position in FIG. 1A to massage the upper back, and then reposition to the position in FIG. 1B to massage the lower back. The roller may be repositioned easily without removing the straps from the door.

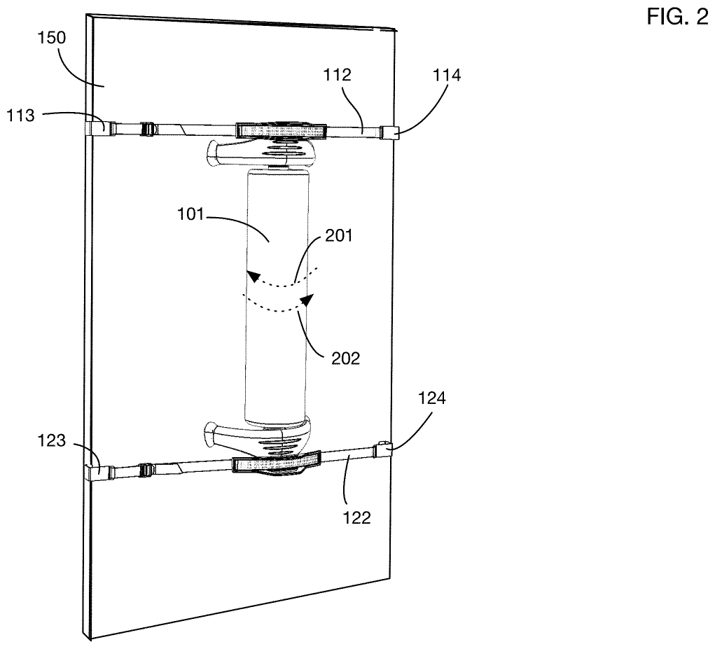

FIG. 2 shows an additional degree of freedom provided by one or more embodiments of the invention, which offers additional flexibility and convenience for the user. The straps 112 and 122 be oriented horizontally around door 150, with hoods 113, 114, 123, and 124 along the edges of the door instead of along the top and bottom as in FIG. 1A. This arrangement orients roller 101 vertically instead of horizontally as shown in FIG. 1A. Rotation left 201 and right 202 of roller 101 provides a different set of massages and therapies for the user that may be complementary to those provided in the horizontal orientation of FIG. 1A. Roller 101 and the stands may be shifted left and right by sliding the strap holders along the straps.

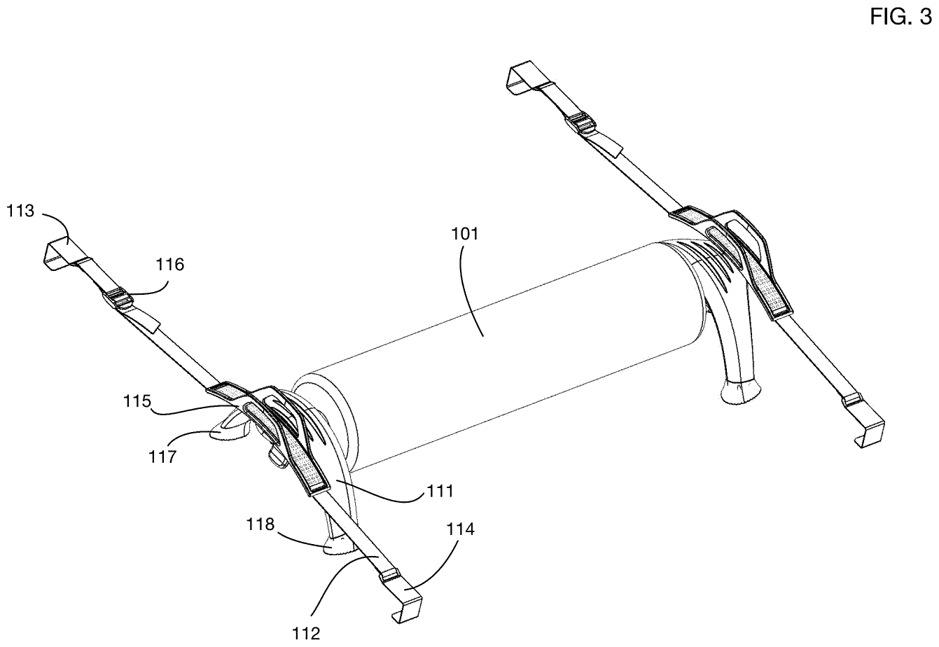

FIG. 3 shows a view of the roller, stands, and straps when the embodiment is not mounted to a door or other surface. Focusing on the left stand for illustration, cylindrical foam roller 101 attaches to stand 111. Stand 111 has feet 117 and 118. Strap holder 115 is attached to the body of stand 111. Strap 112 runs through slots in strap holder 115. Strap 112 can be tightened or loosened with cinch 116. Strap 112 terminates in hooks 113 and 114.

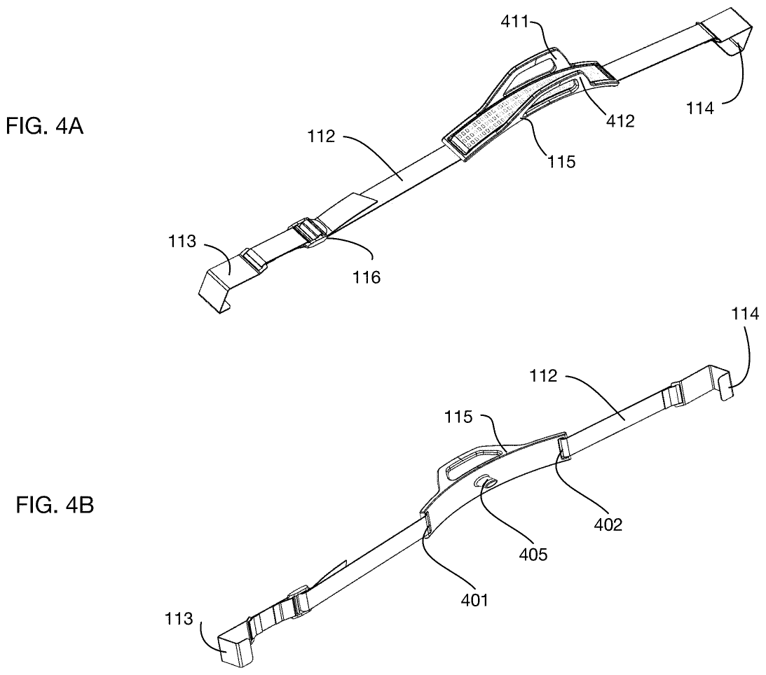

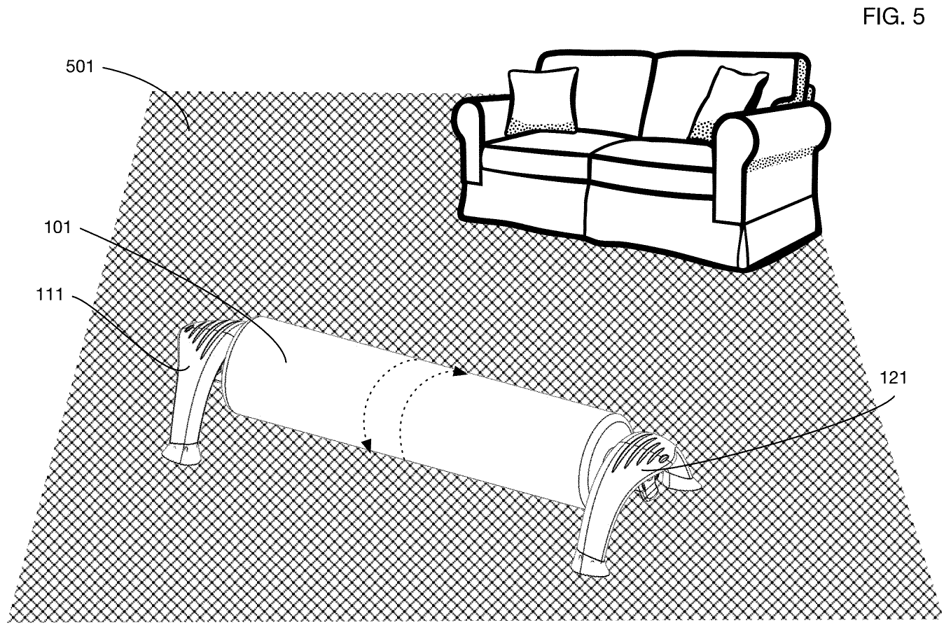

FIGS. 4A and 4B show detailed views of strap 112 and strap holder 115; FIG. 4A is a top view and FIG. 4B is a bottom view. Strap holder 115 has handles 411 and 412 that the user can grasp to pick up the entire assembly or to move the stands and roller along the straps for repositioning, as shown for example in FIGS. 1A and 1B. In bottom view 4B, slots 401 and 402 are visible; the strap goes through these slots and runs along the top of strap holder 115 between the two slots. A protrusion 405 on the bottom of strap holder 115 is used to attach the strap holder to the base of the stand. In this embodiment, the strap holder can be easily attached and detached from the stand, which allows the roller and stands to be used with or without the mounting straps. Use without the straps is illustrated in FIG. 5, which shows roller 101 and stands 111 and 121 on floor 501. Strap holders 115 and 125 have been detached from stands 111 and 121, respectively. A user may use the roller on the floor in this configuration; the strap holders can be easily reattached for mounting to a door or other surface. The roller 101 is stationary in its position on the floor because it is held in position by stands 111 and 121. The roller is elevated off the floor by the stands so that it may rotate freely in either direction.

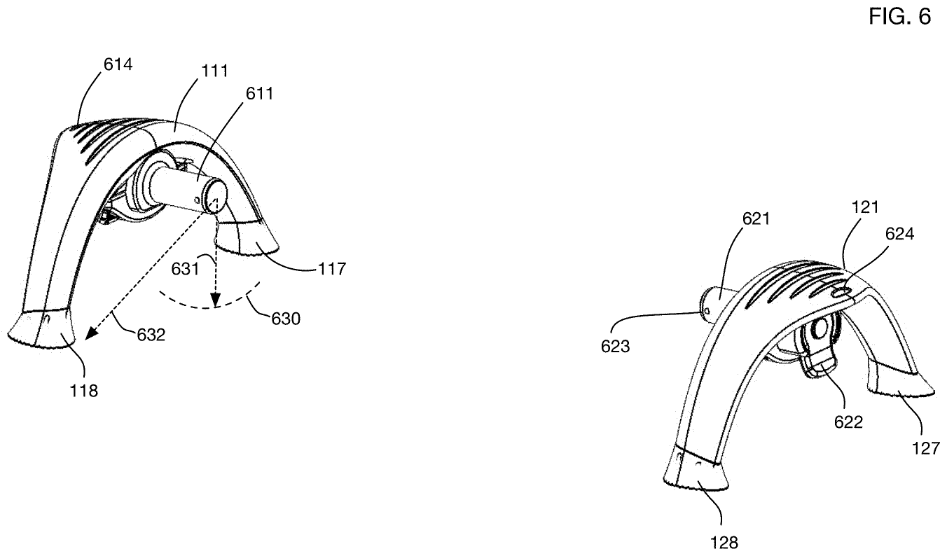

FIG. 6 shows a detailed view of stands 111 and 121. Attached to the body of each stand is a connector couples to an axle in the middle of the foam roller (described below). Connector 611 extends from stand 111 and connector 621 extends from stand 121. The connectors are offset from the mounting surface (such as a door surface or a floor) sufficiently to allow for free rotation of the foam roller. For example, distance 631 from the center of connector 613 to the outer surface 630 of the foam roller is less than the distance 632 from the connector to the mounting surface of feet 118 and 117. In one or more embodiments the gap between the mounting surface and the surface 630 of the foam roller may be for example approximately one inch; this distance allows for free rotation and also ensures that the user's clothes cannot be trapped between the roller and the mounting surface.

A locking latch 622 is visible for connector 621 in stand 121; this latch may for example lock the connector into the axle to prevent movement along the axle's axis; even when locked the connection between the axle and the connector allows for free rotation of the axle (and thus the foam roller). A small button 623 is shown on connector 621; a similar button may be on the opposite side. These buttons latch the connector into the axle. Hole 614 accepts protrusion 405 of strap holder 115 to attach the strap holder to the stand. Locking latch 622 may in one or more embodiments be implemented as a quick disconnect mechanism, for example by asserting the element, connector 621 may disconnect from the roller in any known manner.

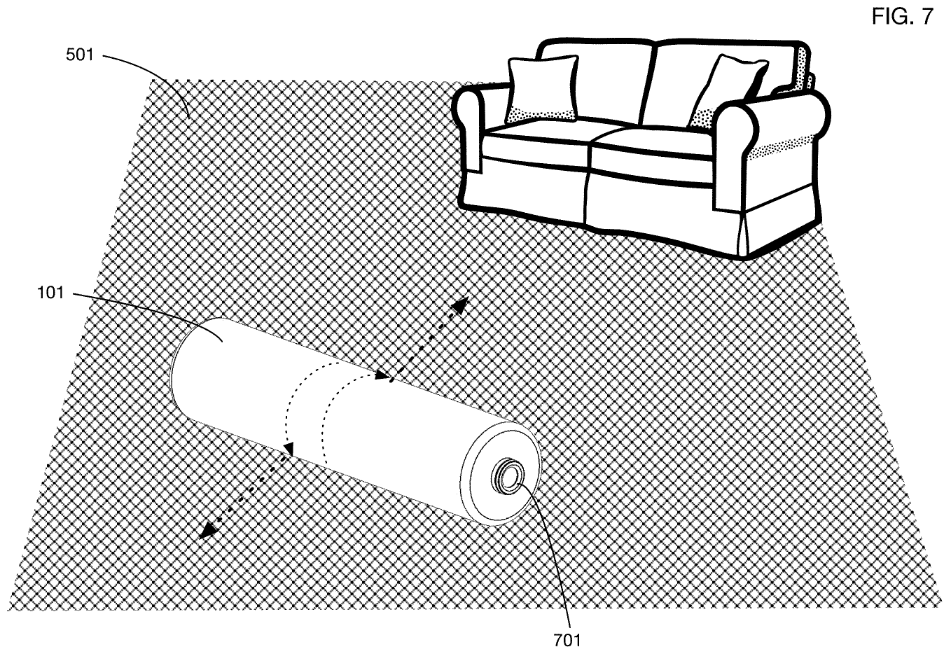

In one or more embodiments, the stands may be detached from the foam roller, allowing the roller to be used by itself. This configuration is shown in FIG. 7, where roller 101 is placed directly on floor 501. In this configuration the roller moves along the floor when it is rolled (like a traditional non-stationary foam roller). This configuration provides additional flexibility for the user. The user may use the roller 101 by itself, as in FIG. 7, or on a floor with stands, as in FIG. 5, or mounted to a door horizontally, as in FIG. 1A, or mounted to a door vertically, as in FIG. 2.

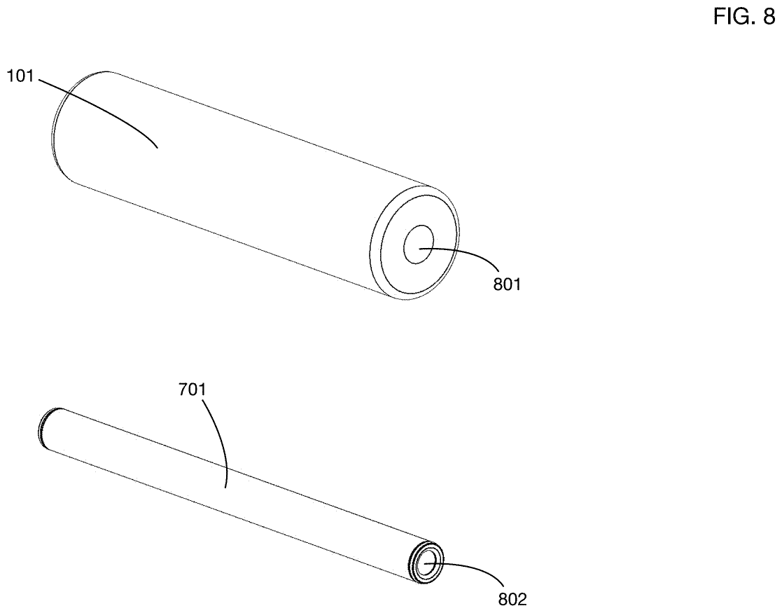

FIG. 7 also shows central axle 701 in the foam roller 101. This axle provides an attachment point for the stands. FIG. 8 shows an exploded view of foam roller 101, with a hollow center 801 along the roller's longitudinal axis, and axle 701 that fits into this area 801. In this embodiment, the center 802 of the axle is hollow, so that it can accept the connectors 611 and 621 of stands 111 and 121, respectively. One or more embodiments may use an opposite configuration with protrusions from the axle 701 that fit into slots or holes in the stands. One or more embodiments may use any configuration of axle and stands that provide for coupling between the stands and the axle that allows for free rotation of the axle and foam roller around the stands.

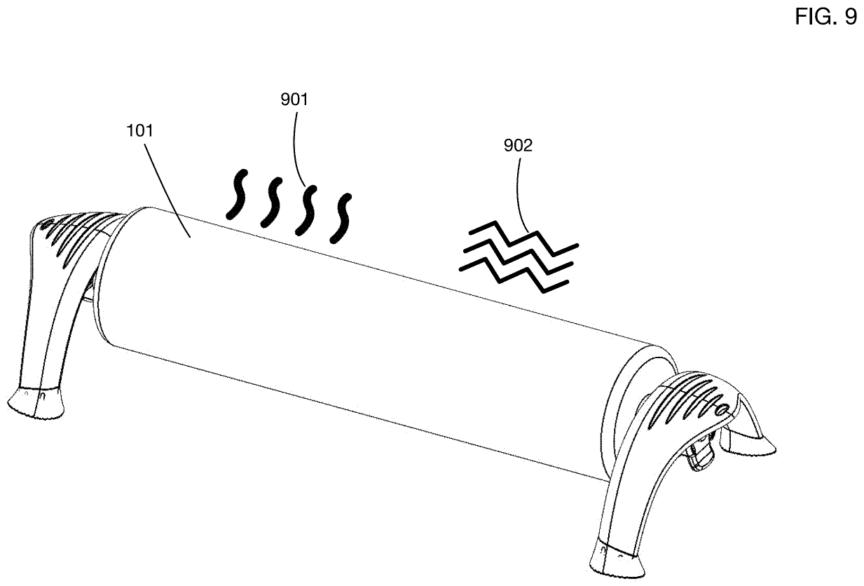

In one or more embodiments, one or more mechanisms or elements may be integrated into or coupled to the foam roller to provide additional features that may provide therapeutic benefits to the user. FIG. 9 shows two illustrative examples. A heating element 901 may be integrated into the roller 101 to provide heat. This heating element may be for example electric, powered by battery or external power. One or more embodiments may provide a cooling element instead of or in addition to a heating element. In one or more embodiments the foam roller may have an integrated container that may be filled with hot or cold water, or ice, to provide heating or cooling. A vibration element 902 may be integrated into the roller 101 to provide vibration. This vibration element may incorporate any type of actuator or actuators. In one or more embodiments the amount or frequency of vibration may be controllable by the user.

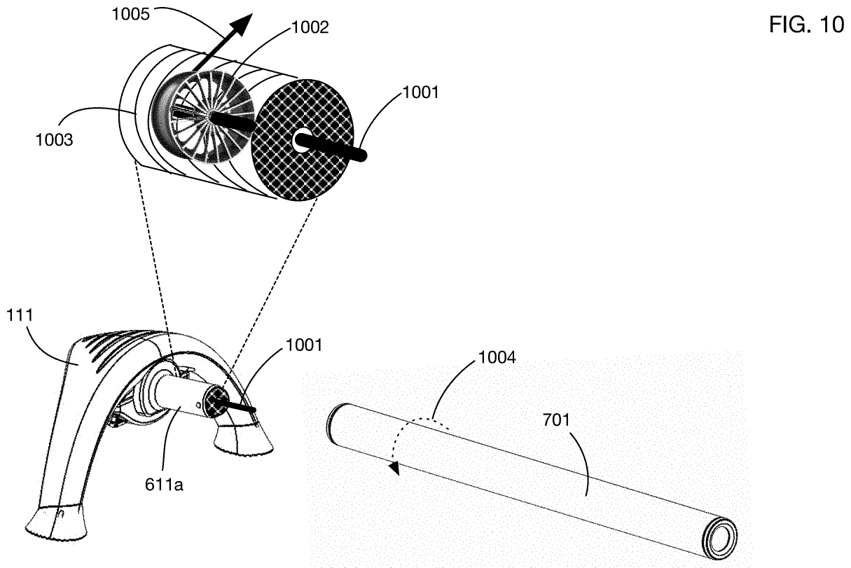

One or more embodiments may incorporate one or more resistance elements that provide resistance to the rolling motion of the roller. This resistance may be fixed, or it may be variable, for example increasing as the speed of the roller increases. FIG. 10 shows an illustrative embodiment with a resistance element integrated into the coupling between stand 111 and axle 701. In this embodiment, axle 701 attaches to a shaft 1001 that is attached to an impeller 1002 enclosed in a housing 1003. The impeller 1002, shaft 1001, and housing 1003 are integrated into the connector 611a extending from the body of stand 111. The housing 1003 may be filled for example with a fluid that provides resistance to the rotation of impeller 1002. This resistance may be speed dependent, with faster rotation leading to greater resistance. The resisting torque 1005 opposes the direction of rotation 1004 of the shaft 701. One or more embodiments may use any type of resistance mechanism, including but not limited to an impeller. For example, resistance may be frictional or magnetic instead of based on fluid pressure.

The foam roller in any or all of the configurations illustrated above may be used for a variety of exercises, stretches, massages, and therapies. Several innovative therapies may be enabled using these roller configurations, including for example passive rolling, a rock-and-roll technique, and a low-pressure lower back technique. These therapies and their benefits are described below.

(1) Passive Rolling: Passive rolling is a new self-massage technique where the user places a specific muscle on top of the roller, brings their body into a resting position and rotates the roller with their hand in order to feed the relaxed muscle over the cylinder. This technique is different from traditional active rolling where the user engages their entire musculoskeletal system to perform a movement over the surface of the roller. Passive rolling provides five benefits over active rolling.

(a) Less Pain: With active rolling, users must perform a full body movement. In order to produce the full body movement to roll over the muscle, the user must engage the same muscles they are using to move their body as well as the muscles they are massaging. The full body movement produces unwanted or unnecessary pressure and over stimulates the sensory nerves in the muscle causing the sensation of pain. in contrast, in passive rolling, the user's body is in a resting position, so they can keep the intended muscle massaged relaxed, while using micro-adjustments to massage the muscle.

(b) Improved safety: With active rolling, for users with sensitive muscles, that are overweight or are weak and have a difficult time supporting their bodyweight, using more than necessary bodyweight and applying too much pressure can cause trauma to the muscle. The majority of the education material readily available online teaches the “No Pain, No Gain” mentality and that one should roll through the pain. For example, when rolling the calf muscle, users have to prop and move their entire body in order to move the muscle over the roller. With passive rolling, users can apply the desired amount of bodyweight or pressure, reducing the likelihood of trauma to the muscle. For example, when rolling the calf, users can remain in a seated position, load only the weight of their leg onto the roller and then manually rotate the roller under the muscle.

(c) Deeper massage: With active rolling, a macro-adjustment or a full-body movement engages the same muscles required to move the body as well as the muscle being massaged. Users are only able to massage the top layer of muscles and are unable to access/penetrate the superficial layer of flexed muscles. With passive rolling, users can maintain a relaxed muscle allowing the roller to penetrate to deeper layers of muscles.

(d) Better navigation: With active rolling, too much pressure can over stimulate the sensory neurons, which floods the brain with too much information. With too much stimulation/sensation/information, it is difficult to differentiate an unhealthy (stressed or overactive) muscle from a healthy muscle that doesn't need to be massaged. With passive rolling, keeping the muscles relaxed allows users to better differentiate between the changes in the quality of the tissue or the feeling it produces, from one muscle to the other. Recognizing these differences allows users to target specific muscles and be more effective in structural alignment and reconditioning.

(e) Improved effectiveness: With active rolling, if a muscle is under tension or is flexed, a release cannot occur. With passive rolling, a release can only occur when a muscle is relaxed.

(2) Rock & Roll Technique: This technique is a self-massage navigating technique where the user performs a series of horizontal (Rock) and vertical (Roll) movements to steer through the multi-dimensional terrain of the musculoskeletal structure. Massage therapists are educated in the dynamics of the musculoskeletal structure and navigate by feeling for inconsistencies in the muscle tissue. The Rock & Roll Technique teaches users to feel for the same inconsistencies in the muscle tissue that massage therapists do. Combined with the relaxing benefits that passive rolling produces, users can better interpret, locate, and target specific muscles. The Rock & Roll Technique produces a tracing effect that allows users to locate the attachments of the muscle, increasing the effectiveness in relaxing tight, tense and overactive muscles.

(3) Low-pressure lower back technique: A traditional lower back technique is performed by placing the roller under the user's lower back (lumbar), lifting the upper body up off the floor (similar to a sit-up position) and rolling up and down the spine. This is unsafe and ineffective for the following reasons: a) rolling directly on the vertebrae; b) too much pressure on spine; c) can cause the lower ribs to come out of alignment; d) can cause the user to strain core muscles in order to support the weight of their upper body; e) can cause unnecessary pressure to the kidneys and the liver, which have no protection from the rib cage; f) it is ineffective because the user is flexing/tensioning all of their trunk muscles in order to support their upper body, and a muscle cannot release while under tension. An improved technique is performed by placing the roller under the lower back (lumbar) while resting the upper body and feet on the ground. By slowly lifting/hovering one leg at a time causes that one side of the user's lower back to dip/load onto the roller in order to apply pressure. This is safer and more effective for the following reasons: a) no rolling on the vertebrae; b) no rolling on lower ribs; c) less pressure on the spinal column; d) resting position allows user's back muscles to remain relaxed, producing a deeper massage and a release in the muscle.

While the invention herein disclosed has been described by means of specific embodiments and applications thereof, numerous modifications and variations could be made thereto by those skilled in the art without departing from the scope of the invention set forth in the claims.

What is claimed is:

1. A stationary foam roller with an adjustable mount comprising:
a cylindrical foam roller;
an axle along a longitudinal axis of said cylindrical foam roller and fixedly coupled to said cylindrical foam roller;
a pair of stands, each stand of said pair of stands comprising
a base comprising one or more bottom surfaces configured to rest upon a mounting surface;
a body coupled to said base;
a connector coupled to or integrated into said base and configured to detachedly couple with one end of said axle, wherein
a coupling between said connector and said one end of said axle enables said axle to rotate freely relative to said body; and
a distance between said connector and said one or more bottom surfaces is greater than a radius of said cylindrical foam roller, enabling said foam roller to rotate freely when said connector is coupled to said axle; and,
a strap mount comprising
a strap;
a hook at each end of said strap, said hook configured to attach to said mounting surface;
a strap holder configured to couple with said body, said strap holder comprising one or more slots, wherein said one or more slots are configured to
accept and hold said strap; and
slide along said strap to enable said strap holder to be positioned at multiple positions along said strap.

2. The system of claim 1, wherein said mounting surface is a door.

3. The system of claim 1, wherein
said axle is hollow; and,
said connector comprises a cylindrical protrusion from said body configured to fit inside said axle.

4. The system of claim 1, wherein said strap mount is detachably coupled to said body.

5. The system of claim 1, wherein said each stand further comprises a locking mechanism configured to lock said connector to said one end of said axle to resist movement of said connector relative to said one end of said axle in a direction of said longitudinal axis of said cylindrical foam roller.

6. The system of claim 1, wherein said base comprises one or more feet, each foot of said one or more feet comprising a compliant material along a bottom surface of said each foot.

7. The system of claim 1, wherein said cylindrical foam roller comprises a vibrating element.

8. The system of claim 1, wherein said cylindrical foam roller comprises a thermal element.

9. The system of claim 1, wherein said each stand further comprises a resistance element configured to apply a torque to said axle in a direction opposite an angular velocity of said axle.

10. The system of claim 9, wherein said resistance element comprises an impeller coupled to said connector.

11. The system of claim 10, wherein said resistance element further comprises a housing containing a fluid and containing said impeller.

12. The system of claim 1, wherein said stationary foam roller is configured to enable a user to manually roll the cylindrical foam roller for passive rolling.

13. The system of claim 1, wherein said stationary foam roller is configured to enable a user to engage cylindrical foam roller in horizontal movements and vertical movements for rock and roll therapy.

14. The system of claim 1, wherein said stationary foam roller is configured to enable a user to place lumbar of a user's spine on the cylindrical foam roller and the user's upper body and feet on the floor for low-pressure lower back therapy.

15. The system of claim 1, wherein said strap mount is configured to be removed to enable therapy of horizontal surfaces.

16. The system of claim 1, further comprising at least one quick disconnect coupling element that enables the cylindrical foam roller to be removed rapidly from said pair of stands.

17. A stationary foam roller with an adjustable mount comprising:
a cylindrical foam roller;
a hollow axle along a longitudinal axis of said cylindrical foam roller and fixedly coupled to said cylindrical foam roller;
a pair of stands, each stand of said pair of stands comprising
a base comprising one or more one or more feet, each foot of said one or more feet comprising a compliant material along a bottom surface of said each foot, wherein said bottom surface is configured to rest upon a mounting surface;
a body coupled to said base;
a connector coupled to or integrated into said base and configured to detachedly couple with one end of said axle, said connector comprising
a cylindrical protrusion from said body configured to fit inside said axle;
wherein
a coupling between said connector and said one end of said axle enables said axle to rotate freely relative to said body; and
a distance between said connector and said one or more bottom surfaces is greater than a radius of said cylindrical foam roller, enabling said foam roller to rotate freely when said connector is coupled to said axle;
a resistance element configured to apply a torque to said axle in a direction opposite an angular velocity of said axle, said resistance element comprising
an impeller coupled to said connector; and
a housing containing a fluid and containing said impeller;
a locking mechanism configured to lock said connector to said one end of said axle to resist movement of said connector relative to said one end of said axle in a direction of said longitudinal axis of said cylindrical foam roller; and,
a strap mount comprising
a strap;
a hook at each end of said strap, said hook configured to attach to said mounting surface;
a strap holder configured to detachably couple with said body, said strap holder comprising one or more slots, wherein said one or more slots are configured to
accept and hold said strap; and
slide along said strap to enable said strap holder to be positioned at multiple positions along said strap.

18. The system of claim 17, wherein said stationary foam roller is configured to enable a user to
manually roll the cylindrical foam roller for passive rolling,
or
engage cylindrical foam roller in horizontal movements and vertical movements for rock and roll therapy
or
place lumbar of a user's spine on the cylindrical foam roller and the user's upper body and feet on the floor for low-pressure lower back therapy.

19. The system of claim 17, wherein said strap mount is configured to be removed to enable therapy of horizontal surfaces.

20. The system of claim 17 further comprising at least one quick disconnect coupling element that enables the cylindrical foam roller to be removed rapidly from said pair of stands.
